(19) United States
(12) Patent Application Publication
(10) Pub. No.: US 2007/0080533 A1
(43) Pub. Date: Apr. 12, 2007

(54) Security document, method for producing a security document, and the use of a security document

(75) Inventors: Anton Bleikholm, Ecublens (CH); Pierre Degott, Crissier (CH); Claude-Alain Despland, Lausanne (CH); Edgar Muller, Fribourg (CH)

Correspondence Address: SHOEMAKER AND MATTARE, LTD, 10 POST OFFICE ROAD - SUITE 110, SILVER SPRING, MD, 20910, US

(73) Assignee: SICPA Holding S.A., Prilly (CH)

(21) Appl. No.: 10/576,357

(22) PCT Filed: Nov. 4, 2004
(86) PCT No.: PCT/EP04/12465

§ 371 Date: Apr. 19, 2006

(30) Foreign Application Priority Data
Nov. 7, 2003 (EP) 03025531.9

(51) Int. Cl. B42D 15/00

(52) U.S. Cl. 283/72

(57) ABSTRACT

Security document, such as a banknote, a value paper, an identification document, an access card, a security label or packaging, comprising an imprint-able substrate, chosen from the group of papers, cardboards, textiles and polymer sheets, as a first constituting part, and at least a second constituting part, chosen from the group of printing inks, security threads, windows, fibers, planchettes, foils, and decals, wherein a same security element is contained at least a first time in or on one of its constituting parts and at least a second time in or on another of its constituting parts. Method for producing a security document, characterized in that a same security element is applied at least a first time in a first step to one constituting part of said document, and at least a second time in a second step to another constituting part of said document.

The invention is in the field of security documents, such as banknotes, value papers, identity, access or certification documents, security labels or packaging and the like. It provides security documents which have enhanced resistance against counterfeiting, in particular counterfeiting involving diversion of elements (paper, ink, etc.) from the security document's manufacturing chain, through a customization of the “security chain” with the help of communicating security elements or features, as well as a method for producing said documents and the use of security elements for related security features according to the independent patent claims.

Security documents, in particular long-lived security documents requiring high resistance against counterfeiting, such as banknotes or identity documents, are usually protected by several layers of different security elements (security features), which are chosen from different technology fields, manufactured by different suppliers, and embodied in different constituting parts of the security document. To break the security document, the counterfeiter would need to obtain all of the implied materials and to get access to all of the required processing technology, which is a hardly achievable task.

The manufacturing of a banknote, as an example, requires a special banknote paper (which may contain watermarks, security threads, fibers, planchettes, luminescent particles, windows, foils, decals, coatings etc.), which must be imprinted with particular inks (which may contain security dyes, pigments and further security additives), using dedicated intaglio and other high-security printing equipment. Contrary to commercial printing applications, security printing relies on several different printing techniques combined together on a same document. More recently, banknotes also contain particular foils and other add-ons, which must be applied by dedicated equipment. The materials and the equipment needed to make a banknote are only available from specialized suppliers, and the banknote can only be produced at a high-security printing work by skilled operators.

The security thread is another traditional element of anti-falsification paper for banknotes and other security documents. Embedded security threads are particularly difficult to counterfeit, because i) they cannot be produced by the paper- or substrate-manufacturer, but ii) they need to be incorporated into the printing substrate at the paper mill, during the substrate's manufacturing step. This necessary access to two different manufacturing technologies is a hurdle that most counterfeiters in the past were unable to take; they were thus forced to either imitate the security thread by an easy discovered, printed fake, or to divert or steel authentic security paper. The latter is at present becoming a particular threat to security documents.

The first-generation security thread for currency was a metal- or a metallized polymer-strip, entirely buried within the currency paper, and authenticate-able either by looking at it in translucency, or by detecting its electric or magnetic properties with the help of a corresponding device. More sophisticated versions of the security thread include the window-threads disclosed in EP 059 056 A1 (A. J. Tooth and N. Pask); EP 518 740 B1 (M. Camus); EP 625 431 B1 (H. Mück and S. Harms) and others. The window-thread is partly buried within the paper and partly lying open at the surface of the paper, and therefore allows for a direct visual authentication of the thread's overt security features at the sites where it appears at the paper surface. As a direct consequence of this visual authenticate-ability, a high number of imprinted and/or selectively demetallized threads have been disclosed in the art, which are now extensively used in the banknote paper industry (see e.g. H. Mück and S. Harms; EP 625 431 B1).

To protect the security thread's imprinted or otherwise incorporated security elements, the threads are preferably manufactured as a laminated sandwich, having the security elements contained between two thin layers of polyester foil or of another suitable plastic material. Such laminated threads were disclosed by W. Kaule et al. in U.S. Pat. No. 5,324,079 and U.S. Pat. No. 5,509,691. Similar UV- or E-beam laminated threads were further disclosed by J. Hilburger et al. in EP 1 348 576 A2. Said laminated threads may comprise all types of security elements such as infrared-absorbers, luminescent compounds, magnetic compounds, metallic layers, and optically variable layers.

A particular laminated window thread, comprising an optically variable interference coating, has been disclosed by J. N. Disano et al. in U.S. Pat. No. 6,447,630. Said interference coating is manufactured by high-vacuum deposition of a multi-layer interference stack onto a carrier plastic sheet, and subsequently protected by laminating a second plastic sheet over it. Currency paper containing said optically variable thread, which changes color depending on the viewing angle, is currently manufactured by the Canadian company AGRA Vadeko Inc. and has been used for quite a number of currencies, among others the 100 NTD (New Taiwan Dollar), which contains a magenta-to-green color-shifting thread. The Vadeko window-thread is available in a number of different base colors with their corresponding color shifts.

There is actually much concern at the issuing authorities about securing the sources of the different elements which are put together in the manufacturing of currency or other security documents. Such can be brought about with the help of mutually corresponding (communicating) security elements (features), i.e. by intentionally creating a correspondence between two or more security elements, introduced at different production steps and sites into different constituting elements of the security document.

WO 98/55333 A1 discloses a security paper, which has a window thread matching the color and the gloss of its surrounding (i.e. the banknote paper) in the range of the visible spectrum, remaining thus invisible to the unaided eye, and which additionally comprises a covert security element for authentication purposes, such as a luminescent compound which, upon excitation with UV-light, emits light of longer wavelength inside or outside the visible spectral range. Said security thread does, however, not allow for the immediate visual detection of a diverted currency paper or the like.

Another example of communicating security elements or features is the “Self-verifying security document” disclosed by J. C. Taylor et al. in WO 98/15418 A1: A security document, such as a banknote, comprises a plastic window and printed indicia on a substrate. The plastic of the said window contains a dye, representing an optical filter, and the said indicia are printed as a metameric color pair, i.e. using two slightly different color inks, which are not distinguished by the unaided human eye (e.g. a first yellow and a second yellow). If the said plastic window of the banknote is now folded back over the said metameric printed indicia, some of them remain visible, and some others disappear, because the light reflected at them is filtered out by the plastic window. For the “self-verifying”-effect to properly work, the dye in the plastic window (which is introduced during manufacturing of the substrate) and the pair of metameric pigments in the printing inks (furnished by the ink maker and applied in the printing works) must correspond.

The implementation of communicating security features would be of particular value in the case of optically variable ink (OVI®) on currency. Communicating OVI® security features should noteworthy enable a quick, visual double-checking of a currency bill's authenticity. The already mentioned 100 NTD (New Taiwan Dollar) bill contains, in addition to the said magenta-to-green color-shifting window-thread, as well a magenta-to-green intaglio-printed “100” OVI® denomination. However, the correspondence of both security elements, i.e. their match with respect to color and angle-dependent color-shift, is not sufficient to allow for a cross-authentication. This is a consequence of the fact that both security elements were selected independently from each other, and are, in consequence, of different specification and nature.

Noteworthy, the said, optically variable security thread comprises a homogeneous, native thin-film multi-layer interference stack. The optically variable intaglio printing, on the other hand, comprises an imperfectly reconstituted layer of thin-film interference platelets of the optically variable pigment. The only observation an alert user is able to make upon looking at and tilting the said 100 NTD bill is that there is a magenta-to-green color shift on both, the thread and the denomination. He will not be able, however, to determine if said both optically variable security elements correspond, in the sense that they can be traced to a same common source.

It would be highly desirable, for tracing the authenticity of the various constituents entering into the manufacturing of a banknote, such as the paper, the printed inks, and various add-ons, to have a same security element applied to several of these constituents at different places. E.g. an ink containing an optically variable security element could be present a first time in or on the security thread, and a second time in the form of an appropriate printed design on the banknote substrate, such that an easy, visual comparison of both can be made. This would, among other benefits, allow for a better control and customization of the banknote substrate manufacturing for determined currency editions and denominations, and therefore help the issuing authorities to fight against currency paper and ink diversion.

The present invention discloses a security document, having communicating security features embodied as security elements in or on its different constituents. Said security elements can be comprised in an ink or a coating composition and may be of the overt (i.e. visible to the unaided human eye) or of the covert (i.e. visible or detectable only with the help of an instrument) type. Preferably, said security elements are chosen from the group of optically variable elements, such as multi-layer thin film interference pigments. Their double incorporation allows to establish an unambiguous link between the currency substrate and/or a constituent of it such as the security thread, fibers, planchettes, a window, a foil or a decal, and/or printed indicia applied to the said currency substrate.

Said communicating security features are embodied by security elements which are introduced at least twice, typically a first time during the manufacturing of the substrate or of a constituent of the substrate, and a second time via an ink or coating during the imprinting of the substrate. Communicating security features can be made customer- and/or application-specific, to an extent that a diversion or falsification of a constituting part of the security document, such as the ink or the printing substrate, will become immediately evident to the unaided human eye in case of an overt feature, or easy to recognize with the help of a corresponding device in case of a covert feature.

The present invention concerns thus a security document carrying communicating security features which allow for the immediate, visual or instrumental detection of diverted currency constituents, such as paper, ink or foil, as well as a method of producing said security document and the use of security elements as a security feature. More particularly, a security document is disclosed wherein a same, ink-based security element, preferably an optically variable element, is contained a first time on or in the security document's substrate or on or in a constituent of it such as a security thread, a window, a foil, etc., and a second time in an ink or coating printed on said security document's substrate. Said substrate may hereby be a paper-, a cardboard-, a textile- or a polymer-based substrate.

Throughout the present description, the term “security element” shall be used for a particular material, such as a thin-film interference pigment, a luminescent material, a spectrally selective absorber, etc., which can be incorporated into a security document for authentication purposes. The term “identifiable properties” shall encompass in the sense of the present invention the visual and/or other effects displayed by a security element, such as angle-dependent color change, light emission, reflection, electric or magnetic properties, absorbtion, temperature-dependent changes and other physical phenomena which may be identifiable by a sensor or by the human, particularly by the human eye.

According to the invention, a security document, such as a banknote, a value paper, an identification document, an access card, a security label or packaging, comprising a substrate, chosen from the group of papers, cardboards, textiles and polymer sheets, as a first constituting part, and at least another constituting part, chosen from the group of printing inks, security threads, windows, fibers, planchettes, foils, and decals. Said security document has a first security element applied or added to one of its constituting parts, and said security element has identifiable properties. These properties may be the viewing angle dependent color change of optical variable pigments, the color change of a thermochromic or photochromic material, or the shape of a hysteresis of a magnetic material and serve as a first security feature on the security document. The term “adding a security element to a constituting part” shall particularly encompass attaching or incorporating a security element in said constituting part.

At least a further security element is applied or added to at least another of the constituting parts of the security document, having substantially the same properties as the first security elements. These other security elements serve as a second security feature to the security document. In this context, the term “substantially the same” means, that e.g. the viewing angle color dependence of the optical variable pigments or the shape of the magnetic hysteresis is the same within the specifications holding for the security document, even if the security elements were not manufactured in the same way.

Further, the security elements are applied or added to the constituting parts of the security document in such a manner, that their properties can be compared. This comparison serves as a third security feature as it is directly possible to identify the correspondence between the security elements. If the security elements differ in their chemical or physical composition, it must be achieved that they have, nevertheless, comparable properties which may be used for authentication purposes as discussed herein.

It is preferable, that the security element applied or added to different constituting parts of the security document is materially the same, which means that it has not only the same identifiable properties but also the same chemical and/or physical composition.

At least one of said security elements is furthermore preferably contained in an ink or coating. Coating compositions have the advantage that they can be formulated for application on a large variety of different materials, representing therefore an ideal choice for the required, at least two vectors for said security element. A vector for a security element is herein understood as a carrier material comprising the security element, and allowing it to be applied.

In a particular embodiment, at least one of said security elements is applied or added said first time to the substrate itself or a constituent thereof, chosen from the group of security threads, windows, fibers, planchettes, foils, and decals. Said constituent may herein furthermore comprise a laminated sandwich structure of alternating polymer and coating layers. Laminated or UV-bonded polymer-coating-polymer sandwich foils, such as disclosed in U.S. Pat. No. 5,324,079; U.S. Pat. No. 5,509,691 and EP 1 348 576 A2, have the advantage to protect the security elements comprised in their interior from adverse influences of the environment, in particular those arising during the substrate manufacturing process, e.g. where a security thread is incorporated into a printing substrate.

Said security elements may, however, also be contained said first time in a coating applied to said substrate during its manufacturing process at the paper mill, e.g. according to the disclosure of EP 490 825 B1.

Said security element is preferably contained said second time in a ink or coating printed on said imprint-able substrate by the security printer. Security printing is generally the concluding step in the manufacturing chain of the security document, and by this reason the preferred step for closing the security chain by said second application of the security element.

Said security elements may be of overt (i.e. visible to the unaided human eye) or covert (i.e. visible with the help of an instrument) nature; they are preferably chosen from the group comprising optically variable pigments, multi-layer thin-film interference pigments, liquid-crystal pigments, holographic pigments, and interference-coated particles. More preferably, they are chosen from the group of multi-layer thin-film interference pigments, most preferably from the group of pigments having a (metallic) reflector/dielectric/absorber sandwich structure.

Said security elements may, however, also be chosen from the group comprising thermochromic and photochromic pigments. Furthermore, they may be chosen from the group comprising luminescent, infrared-absorbing, UV-absorbing, and magnetic compounds. Still further, it may be chosen from the group of covert security elements comprising micro-engraved or micro-textured flake pigments and forensic marking compounds. The ink or coating containing said security elements may additionally contain all types of further overt and covert security elements. Design elements, such as motifs, indicia, guilloches, logos, etc. can also be introduced on said at least two vectors of the security element, in order to strengthen the communication between them.

Further disclosed is a method for producing a security document, such as a banknote, a value paper, an identification document, an access card, a security label or packaging, comprising an imprint-able substrate, chosen from the group of papers, cardboards, textiles and polymer sheets, as a first constituting part, and at least a second constituting part, chosen from the group of printing inks, security threads, windows, fibers, planchettes, foils, and decals. According to said method a security element having identifiable properties is applied or added to one constituting part of said document, and at least a further security element having substantially the same identifiable properties is applied or added to at least another constituting part of said document in such a manner that the comparison of the identifiable properties is possible.

In this method it is possible to apply or add a same security element to at least two different constituting parts of the security document.

At least one of said security elements is preferably applied through a coating procedure, possibly a first time to the substrate itself or to a constituent of said substrate, and said constituent of said substrate may herein be chosen from the group of threads, windows, fibers, planchettes, foils, and decals, and a second time through printing on said imprint-able substrate by the security printer.

All methods of coating or printing may furthermore be used to apply said security elements, noteworthy intaglio, offset, letterpress, screen-, flexo, gravure, or ink-jet printing, etc., as well as roll-, slit-, spray-, or powder-coating, etc.

The disclosed method has the effect of linking the paper- or substrate-making step more directly into the security chain, by creating a customizable link between the security substrate or a constituent of the security substrate, and at least one security element printed onto said security substrate by a security printer.

Further disclosed is the use of a first and at least a further security element having substantially the same properties in or on at least two different constituting parts of a security document. It is also possible to use the same security element on two or more different constituting parts of the security document.

The invention is now further illustrated with the help of the drawings and the exemplary embodiments.

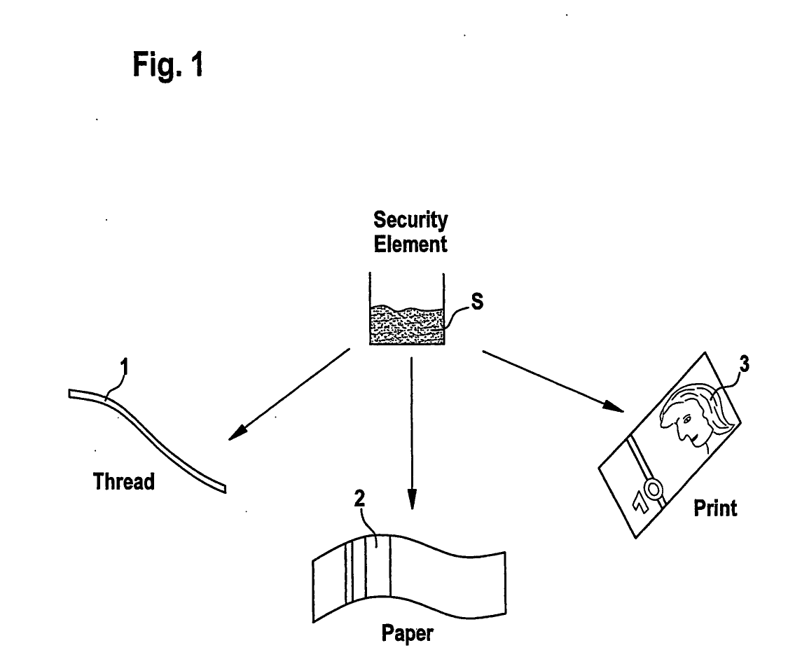

FIG. 1 illustrates the customization of the security chain by the application of a same security element at two or more different constituting parts of a security document.

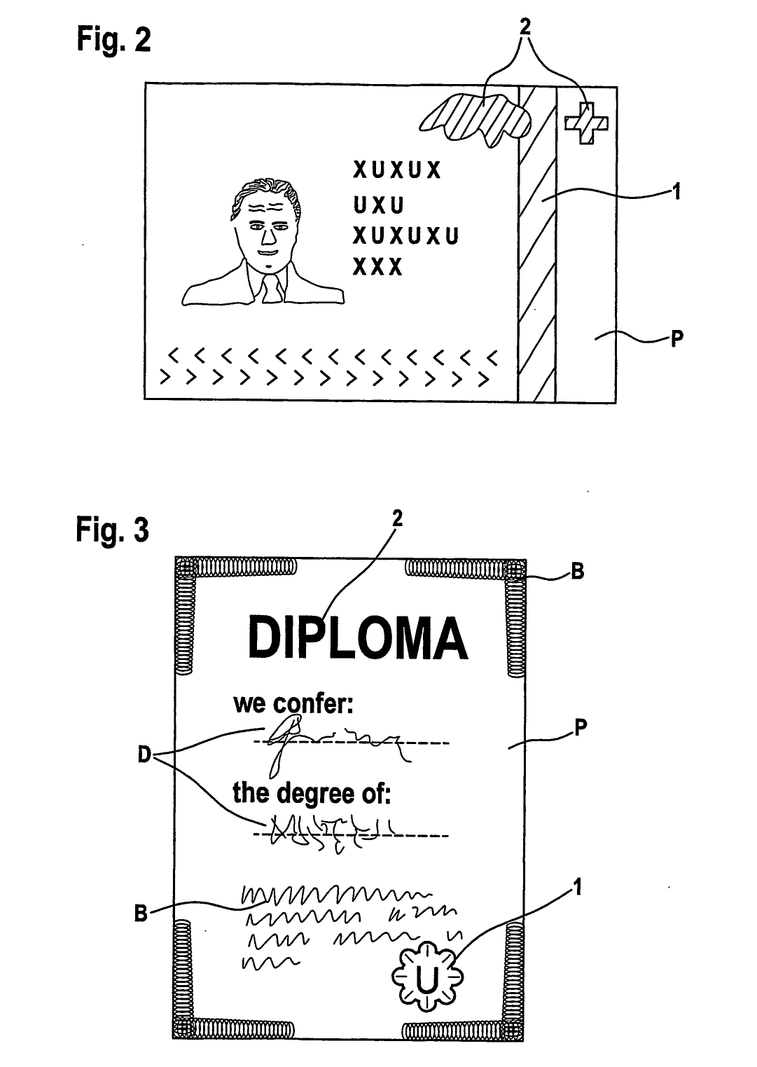

FIG. 2 schematically depicts a passport page of a presented example.

FIG. 3 schematically depicts a Diploma Certificate of a further example.

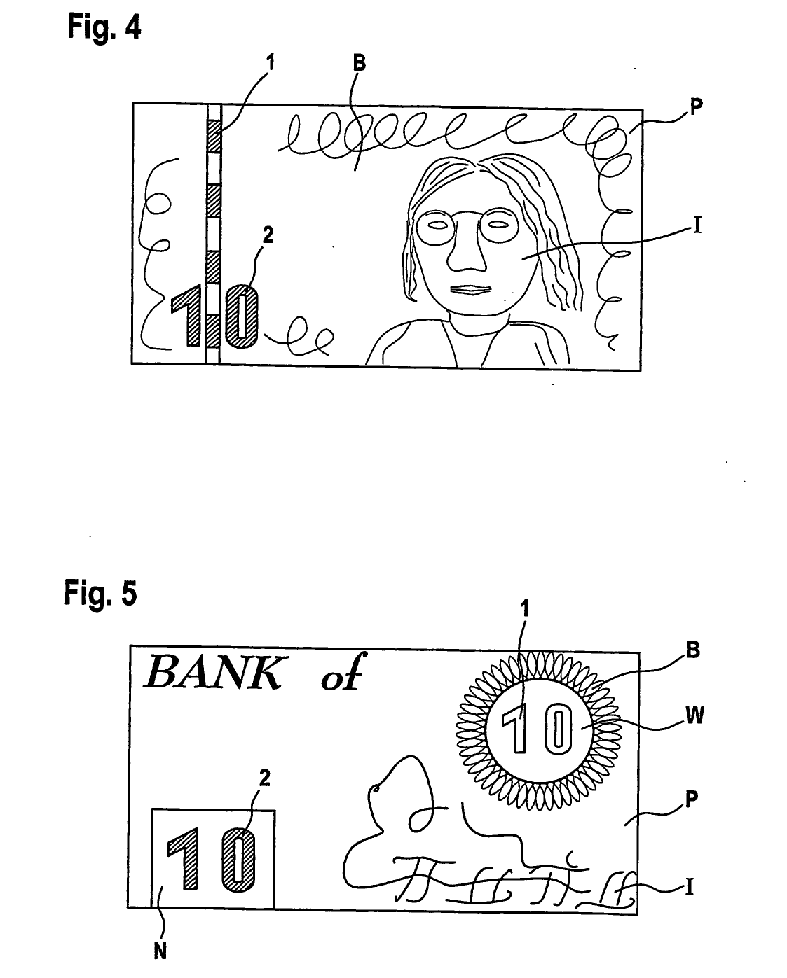

FIG. 4 schematically depicts a banknote with communicating security features.

FIG. 5 schematically depicts another possible embodiment of a banknote.

IN FIG. 1 the customization of the security chain is schematically illustrated. A security element S is applied or added to two or more different constituting parts 1,2,3 of a security document. It is not compulsive that the security element S is the same in or on the different constituting parts 1,2,3, but the properties of the security elements S have to be substantially the same.

In FIG. 2 a possible embodiment of the invention is presented. The second page of a passport usually serves authentication purposes and contains a combination of security features, produced by different processes, such as offset-, intaglio- and screen-printing, using a pre-manufactured security substrate.

In the present example, the printing substrate is a security paper which is already coated by the paper manufacturer, according to the disclosure of EP 490 825 B1, with a customer-specific stripe comprising interference-coated particles (e.g. iridescent pigment), such as can be obtained from Merck (Iriodin®, Colorcrypt®) or from Engelhard (Mearlin®). Said interference pigment is practically invisible under normal view, but shows discrete, viewing-angle dependent colors at certain viewing angles. Pigments of different base colors are available, and further customer-specific colors can be made through blending of the available pigments.

With reference to FIG. 2, a paper substrate P, pre-coated at the paper mill with a stripe as a constituting part 1 comprising a customer-specific iridescent or optically variable pigment O, having a determined color under certain viewing conditions, was imprinted with a screen-printed motive as another constituting part 2; the screen-ink containing again the same said pigment O. The screen-printed motive is hereby disposed adjacent to the pre-coated stripe already present on the paper.

Authentication of the document, effectuated by simple viewing and tilting, relies on that no visible difference appears between the pre-coated stripe and the printed screen-ink motive under all viewing conditions, the properties of the security elements are substantially the same. This is an indication that paper and screen-ink, although manufactured and applied at different sites, respectively, belong to the same customized security chain, which serves as an additional security feature to the document.

Another example is presented in FIG. 3. Holographic flake pigments have been disclosed in U.S. Pat. No. 5,415,950 (J. G. King et al.; based on volume holography), U.S. Pat. No. 6,068,691 (R. G. Miekka et al.; based on surface holography), as well as in further documents. Such pigments can be manufactured to customer specifications in small to large quantities, and allow for the formulation of coating compositions yielding angle-dependent and wavelength-dependent light reflection properties.

The document of the present example, with reference to FIG. 3, is produced by the following sequence of steps, which may be carried out independently from each other and at different sites:

Step 1: Printing
printing of an offset multi-colored background B on a cotton-based security paper P;
screen-printing a motive as a constituting part 2 over the offset-printed background B, using a solvent based screen ink comprising a customer-specific holographic pigment H such as disclosed in U.S. Pat. No. 6,068,691;
finishing operations, such as varnishing, cutting, etc.

Step 2: Personalization
filling in the corresponding personal data D; optionally protecting them with a transparent over-laminate (not shown).

Step 3: Validation
application of a hot-stamping seal (decal) as another constituting part 1, comprising again said customer-specific holographic pigment H.

The hot-stamping seal (decalcomania) is manufactured at specialized premises, using a printing technology of choice (solvent based or UV inks), such as disclosed in U.S. Pat. No. 6,174,634; U.S. Pat. No. 6,143,407; U.S. Pat. No. 5,681,644; U.S. Pat. No. 4,322,467; U.S. Pat. No. 4,299,644; U.S. Pat. No. 3,847,725 and still other documents. It comprises the following layers (from the top to the bottom):
a release-coated, about 100 μm thick polyester carrier sheet;
a polyester sheet, about 10 μm thick, as the decal's upper protecting layer;
a customer-specific design layer, comprising said customer-specific holographic pigment H, about 10 μm thick, applied by gravure printing;
a thermo-adhesive layer.

The authenticity of the finally obtained document requires the screen printed parts and the seal (decal) to exhibit the same color, regardless of the viewing angle as the security elements therein have substantially the same properties.

A preferred embodiment for a banknote is illustrated in FIG. 4. Multi-layer thin-film interference pigments for banknote and other security applications have been disclosed in U.S. Pat. No. 5,084,351 (R. W. Philps) and in related documents.

The banknote of the present example, with reference to FIG. 4, comprises a laminated windowed security thread as a constituting part 1 and a screen-printed denomination motive as another constituting part 2, both comprising green-to-blue optically variable ink (OVI®, SICPA). The laminated security thread is manufactured at specialized premises according to U.S. Pat. No. 5,324,079; U.S. Pat. No. 5,509,691; preferably EP 1 348 576 A2 or similar technology. The polymer layers of said sandwich foil have typically a thickness of the order of 10 μm or less, and the coating layer has a thickness of the order of 10 μm; the overall thickness of the whole polymer sandwich is of the order of 30 μm; and the thickness of currency paper, in which said polymer sandwich foil can be incorporated in the form of a thread is of the order of 100 μm.

One side of a 10 μm polyester foil was imprinted with a layer of UV-curing gravure ink containing 20% green-to-blue optically variable pigment (supplied by FLEX Products Inc., Santa Rosa, Calif.), in the form of a customer-specific motive. A second, similar foil was coated homogeneously on one side with a layer of UV-curing gravure ink containing 5% of the IR-emitting luminescent pigment YVO₄:Nd as a covert security element. After joining the imprinted, respectively coated sides of both foils, the coating was hardened through exposure of the foil to UV light. The so laminated sheet was subsequently converted into security threads, supplied to the papermaker for incorporation as a window-thread into banknote paper.

The so obtained banknote substrate P was imprinted at a security printer's premises with
A two-sided multicolor offset background B;
A two-sided intaglio design I;
A one-sided denomination motive, close to the security thread, applied by screen-printing an optically variable ink comprising 20% of green-to-blue optically variable pigment (supplied by FLEX Products Inc., Santa Rosa, Calif.).

The authenticity of the banknote requires the screen-printed denomination and the windowed security thread to exhibit the same color regardless of the viewing angle as the security elements contained therein have substantially the same properties.

The security thread additionally contains a UV-excited IR-luminescent, for machine authentication.

Another possible embodiment for a banknote is shown in FIG. 5. Circularly-polarizing optically variable pigment on a liquid crystal polymer base, as well as coating compositions containing such, have been disclosed in U.S. Pat. No. 5,362,315 (Ch. Müller-Rees et al.), U.S. Pat. No. 5,683,622 (0. Kratschmar et al.), U.S. Pat. No. 5,824,733 (J. Dobert et al.) and in related documents. Such pigments and coatings are useful as security elements, as they can be authenticated through their color-, color-shifting- and polarization- properties (cf. U.S. Pat. No. 6,570,648 and related documents).

Micro-embossed transparent marking pigment flakes have been disclosed by A. Argoitia et al. in WO 03/11980 A1, U.S. Pat. No. 2003/0031870 A1 and in related documents. Said flakes carry indicia having the size of a few micrometers, which can be made to customer specifications. The indicia-carrying flakes can be viewed and identified in a coating with the help of an in-axis illumination optic microscope or a scanning electron microscope. Corresponding pigments are supplied by FLEX Product Inc., Santa Rosa, Calif.

A polymer substrate for banknote printing has been disclosed in WO 98/13211 A1 (B. A. Hardwick et al.) and in related documents. It consists of a sheet-like base substrate of clear plastics material, of the order of 100 μm thickness. Said plastic sheet is preferably an optically bi-axially oriented polymer, which does not perturb the optical polarization of underlying security features. Said base substrate, which may be a single layer or a laminated sheet, is coated on both sides with an opacifying layer, which may be embodied by an ink and applied by gravure printing. A corona pre-treatment of the plastic material may be applied and adhesion promoters may be added to the ink, as known in the art. Selective windows or half-windows may be let open in said coating process, and the window-areas may be made to carry determined security elements. Polymer banknote substrates are available, e.g., under the trade names Guardian®, Sentinel®, Garrison®, etc. from Securency Pty Ltd., Australia.

In the present example, with reference to FIG. 5, a banknote comprises a polymer substrate P having a transparent security window W carrying a printed optically variable security feature as a constituting part 1, and furthermore having optically variable denomination indicia as another constituting part 2, printed with the same type of optically variable ink onto the opacified part of its surface.

The polymer substrate of the banknote was produced as follows: A corona-treated, clear, 100 μm thick biaxially-oriented poly-propylene foil (obtainable from UCB) served as the base substrate. A customer-specific motive was imprinted to a one-sided area of said base substrate, using a solvent-based gravure ink containing 15% Red-to-Green left-polarizing liquid crystal pigment (obtained from WACKER Chemie; U.S. Pat. No. 5,362,315), together with 5% of micro-embossed transparent flake pigment carrying a repeated “F” sign of 7 μm height (obtained from FLEX Products Inc.). A solvent based opacifying white gravure coating was then applied in two passes to each of both sides of the base substrate, letting open a circular window area around the printed optically variable feature.

The banknote substrate P was subsequently imprinted at the security printer's premises with
A recto-verso multicolor offset background B; providing for a black surface N at the location of the later applied denomination motive;
A recto-verso intaglio design I;
A recto denomination motive, applied over the already provided black surface N by screen-printing a water-based optically variable ink containing 15% Red-to-Green left-polarizing liquid crystal pigment (obtained from WACKER Chemie; U.S. Pat. No. 5,362,315;) together with 5% of micro-embossed transparent flake pigment carrying a repeated “F” sign of 7 μm height (obtained from FLEX Products Inc.).

The optically variable pigment contained in the security window is transparent under ordinary circumstances; for authentication, the window is placed on a black surface, where the authenticity of the banknote requires the screen-printed denomination motive and the optically variable window to exhibit the same color regardless the viewing angle. Again this is due to the security elements contained therein having substantially the same properties.

The micro-embossed transparent marking pigment is invisible to the unaided human eye, but can be authenticated in both, the security window and on the denomination motive with the help of an in-axis illumination microscope (at 500× enlargement).

1-15. (canceled)

16. A security document comprising a substrate (P) as a first constituting part, and at least one other constituting part (1,2,3), and a first security element (S) being applied to or comprised in one of the constituting parts (P,1,2,3), said security element (S) having identifiable properties, the presence of said properties serving as a first authenticating feature for said security document,
wherein at least a further security element (S) having substantially the same identifiable properties is applied to or comprised in at least another of the constituting parts (P,1,2,3) as a second security feature,
wherein said first and second security element (S) are chosen from the group consisting of optically variable pigments, multi-layer thin-film interference pigments, liquid-crystal pigments, holographic pigments, interference-coated particles, thermochromic pigments, photochromic pigments, luminescent compounds, infrared-absorbing compounds, UV-absorbing compounds, magnetic compounds, micro-engraved or micro-textured flake pigments, and forensic marking compounds,
and wherein said first and second security element (S) are applied or added to the constituting parts (P,1,2,3) in a manner to allow a comparison of their properties as a third security feature.

17. A security document according to claim 16, wherein said first and the further security elements are materially the same.

18. A security document according to claim 16, wherein said security document is selected from the group consisting of a banknote, a value paper, an identification document, an access card, a security label and a packaging.

19. A security document according to claim 16, wherein said substrate (P) is chosen from the group consisting of papers, cardboards, textiles, foils, printing layers and polymer sheets.

20. A security document according to claim 16, wherein said other constituting parts (1,2,3) are chosen from the group consisting of printing inks, security threads, windows, fibers, planchettes, foils and decals.

21. A security document according to claim 16, wherein at least one of said security elements (S) is contained in an ink or coating.

22. A security document according to claim 16, wherein at least one of said security elements (S) is contained in or applied to the substrate (P) or one of the constituents thereof.

23. A security document according to claim 16, wherein said substrate (P) comprises a structure of alternating polymer and coating layers.

24. A security document according to claim 16, wherein said security elements are chosen from the group comprising covert security elements.

25. A method for producing a security document comprising a substrate (P) as a first constituting part and at least another constituting part (1,2,3), said method comprising the steps of
a) applying or adding a first security element (S) to one of said constituting parts (P,1,2,3), said security element (S) having identifiable properties, the presence of said properties serving as a first authenticating feature for said security document,
b) applying or adding at least a further security element (S) having substantially the same identifiable properties to another of the constituting parts (P,1,2,3) as a second security feature,
wherein said first and further security elements (S) are chosen from the group consisting of optically variable pigments, multi-layer thin-film interference pigments, liquid-crystal pigments, holographic pigments, interference-coated particles, thermochromic pigments, photochromic pigments, luminescent compounds, infrared-absorbing compounds, UV-absorbing compounds, magnetic compounds, micro-engraved or micro-textured flake pigments, and forensic marking compounds,
and wherein said security elements (S) are applied or added to the constituting parts (P,1,2,3) in a manner to allow a comparison of their properties as a third security feature.

26. A method according to claim 25, wherein materially the same security element (S) is applied or added to two or more different constituting parts (P) of said security document.

27. A method according to claim 25, wherein at least one of said security elements (S) is applied to a constituting part (P,1,2,3) by a coating or printing procedure.
